(19) United States
(12) Patent Application Publication
(10) Pub. No.: US 2013/0185345 A1
(43) Pub. Date: Jul. 18, 2013

(54) ALGEBRAIC PROCESSOR

(71) Applicants: MEIR TSADIK, HOD HASHARON (IL); ASSAF TOUBOUL, NATANYA (IL)

(72) Inventors: MEIR TSADIK, HOD HASHARON (IL); ASSAF TOUBOUL, NATANYA (IL)

(73) Assignee: DESIGNART NETWORKS LTD, RA'ANANA (IL)

(21) Appl. No.: 13/350,850

(22) Filed: Jan. 16, 2012

(51) Int. Cl. G06F 17/17; G06F 7/52; G06F 7/50; G06F 1/03

(52) U.S. Cl. 708/235

(57) ABSTRACT

An algebraic processor as part of a wireless telecommunication system, including pre-computed Look Up Tables (LUT), used for computing a number of different functions using linear interpolation. Preferably, the step of computing is implemented in a multiplier-accumulator having a SIMD structure.

### FIELD OF THE INVENTION

The present invention relates to a processor, in general and, in particular, to an algebraic processor for DSP processing.

### BACKGROUND OF THE INVENTION

In order to perform mathematical functions in a processor at present, either dedicated hardware or software is required. The capability to calculate square root, log, division, and other frequently used functions is not implemented in conventional DSPs. In order to perform such calculations, a different dedicated hardware unit is required for each function—e.g., sine, square root, etc. Typically, only division and square root will be implemented in hardware, and software is provided for calculating other functions. However, when the calculations are carried out by software, many cycles are required to perform each calculation and multiple calculations cannot be performed simultaneously on several operands.

Taylor's theorem gives a sequence of approximations of a differentiable function around a given point by polynomials (the Taylor polynomials of that function) whose coefficients depend only on the derivatives of the function at that point. The theorem also gives precise estimates on the size of the error in the approximation. Taylor's theorem applies to any sufficiently differentiable function f, giving an approximation, for x near a point a, of the form:

$$f ( x ) \approx f ( a ) + {f}^{′} ( a ) ( x - a ) + \frac{{f}^{″} ( a )}{2 !} {( x - a )}^{2} + … + \frac{{f}^{( n )} ( a )}{n !} {( x - a )}^{n} .$$

The quality of the approximation is controlled by the remainder term, which is the difference of the function and its approximating polynomial. For x near enough to a, the remainder will be small.

A mathematical function can be estimated by means of a Taylor series. Any function, i.e., sine, exponent, square root, etc., can be converted to an infinite series of polynomials. The series is built using function values and their derivatives of a specific point. In reality, the series used will not be infinite, but rather will be cut at a certain point. Since the error is limited to the value of the next series element (term), the series can be cut off below the size of the known precision of the representation.

It is known to use linear interpolation to calculate functions. A linear approximation is an approximation of a general function using a linear function. Given a twice continuously differentiable function f of one real variable, Taylor's theorem for the case n=1 states that

f(x)=f(α)+f′(α)(x−α)+R₂

where R₂ is the remainder term. The linear approximation is obtained by dropping the remainder. This is a good approximation for f(x) when x is close enough to α.

Single Instruction Multiple Data (SIMD) processors are also known. A SIMD is a type of multiprocessor architecture in which there is a single instruction cycle, but multiple sets of operands may be fetched to multiple processing units and may be operated upon simultaneously within a single instruction cycle. SIMDs are programmable and can perform different operations depending on the programming for that particular cycle.

There is a long felt need for a device for use in general purpose and DSP processing for performing mathematical calculations rapidly (i.e., in one or a few cycles) and relatively inexpensively.

### SUMMARY OF THE INVENTION

The present invention relates to a device and method for increasing throughput with more efficient use of computing resources by using hardware to estimate a variety of functions by means of a series of polynomials (linear interpolation), rather than performing the precise calculation for each desired function by dedicated hardware or by software.

There is provided according to the present invention an algebraic processor including a programmable hardware unit which includes at least one lookup table for each function to be calculated. Each lookup table has at least two values per entry. The processor further includes an arithmetic engine for performing a mathematical operation on a plurality of operands in a single cycle. While the programmable hardware unit is preferably a vector device, i.e., a SIMD or similar device, alternatively, the hardware unit can be a scalar device.

It is a particular feature of the invention that the arithmetic engine performs the same operation regardless of the function sought. The result depends on the particular look up table from which the operands are taken and the input word whose function is sought.

The look up table includes pre-calculated function values and the derivatives of those values and the arithmetic engine performs interpolation from one of these pre-calculated numbers to the required input value, using Taylor polynomials.

There is also provided, according to the invention, a method for calculating a function of an input word in an algebraic processor. The method includes receiving an instruction, according to a selected resolution, for dividing the input word into an index for a LookUp Table and an input operand. The index is sent to a programmable hardware unit having a LookUp Table including two pre-calculated values for each entry: the function to be calculated at various known values, and the first derivative of those values of that function. Using the index, the hardware unit reads pre-calculated values from the lookup table as operands for a function to be calculated. The processor now utilizes the input operand and the values from the lookup table, using linear interpolation, to calculate an approximation of the required function, in a single cycle.

### BRIEF DESCRIPTION OF THE DRAWINGS

The present invention will be further understood and appreciated from the following detailed description taken in conjunction with the drawings in which:

FIG. 1 is a schematic illustration of an algebraic processor, constructed and operative in accordance with one embodiment of the present invention, and its function.

### DETAILED DESCRIPTION OF THE INVENTION

The present invention relates to an algebraic processor for general purpose processors, especially DSP processors. This algebraic processor has low power consumption and is particularly suited for use in a wireless telecommunication system. The algebraic processor includes pre-computed Look Up Tables (LUT), used for computing a number of different algebraic calculations. Preferably, the step of computing is implemented in a Multiplier-Accumulator having a SIMD structure.

The algebraic processor includes programmable hardware having at least one, and preferably a plurality of lookup tables (LUT), one for each function to be calculated. Each LUT has two values for each entry. The processor also includes an arithmetic engine to perform a single mathematical calculation, interpolation. These calculations utilize linear interpolation to approximate real functions, based on the principle of the Taylor theorem and using the Taylor series. Better approximations can be obtained by performing more iterations.

An input word (x) is divided into two portions—one representing a known value, a₀, and the other representing some differential, dx, where x=a₀+dx. Each look up table includes the pre-calculated values of a particular function at a₀ and the first derivative of the function at a₀. These results, together with the portion representing dx, are input to the arithmetic engine, which calculates the desired approximation. It is a feature of the invention that the decision as to where to divide the bits of the input word (i.e., how many bits are used to form a₀ and how many bits are used to represent dx) can be decided dynamically during operation, and can change as desired, depending on the instruction received regarding the particular function to be approximated. This is useful since the size of the error depends on dx. A preliminary determination of the division between aₒ and dx is selected when the LUTs are planned.

Preferably, a vector device, such as a SIMD (Single Instruction Multiple Data processor) or the like, is used, as described herein, thereby permitting several calculations to be performed in parallel and in a single cycle. For example, utilizing a four lane SIMD, four calculations can be performed in parallel, providing a sustained throughput of four results per cycle. However, it will be appreciated that, alternatively, a scalar device can be utilized to perform the required calculations. It is a particular feature of the invention that the arithmetic engine performs the same operation regardless of the function sought. The results of the different functions depend on which LUT is used and how the input word to be operated on is divided between a₀ and dx.

For purposes of the algebraic processor of the present invention, linear approximation is preferred. The processor receives an input word representing a number which is the operand, for example x, and outputs the desired function of x, e.g., the square root of x. It does this by taking the closest value of the function below x and using this value as the index in the LUT. According to one example, the table includes 256 values of different a₀'s. When the input word includes 16 bits, if 8 bits are selected for a₀, 8 bits will remain for dx. Alternatively, a₀ can be selected with fewer or more bits, depending on the precision required. Similarly, the table may include more or fewer values, depending on the pre-selected size of a₀ , which is determined by the required accuracy.

The values of f(a₀) and f′(a₀) (the first derivative of the function of a₀), are output from the table. The actual value of the function can be estimated by f(a₀)+f′(a₀)*dx. That is, the value of f(a₀) and its derivative (f′(a₀)) are taken from the LUT. Both these values and dx are applied to the arithmetic engine to calculate interpolation, using the Taylor series. Further precision can be obtained by adding also the value of the second derivative of the function at a₀, and more, if desired. Then, the value of f(x) would be f(a₀)+f′(a₀)*dx+f″(a₀)/2*dx². The error is determined by the resolution of the table. If the resolution is chosen properly, the error will be smaller than the representation precision required or possible due to hardware limitations.

The method is as follows. The basic formula for linear interpolation is:

f(x)=f(α₀+dx)=f(a₀)+dx·f′(a₀) The error is

$$e < \frac{1}{2} {dx}^{2} {f}^{″} ( {a}_{0} ) .$$

The input word, x, in the present example, is a 16 bit integer. (The word is preferably represented as fractions). The input word is represented as a₀+dx, where a₀ includes the n most significant bits (MSB) and dx includes the Least Significant Bits (LSB). a₀ is used as the Lookup Table (LUT) index. According to one exemplary embodiment, the LUT generates 32 bits for each lane. 16 bits are used to hold (a₀) and the other 16 bits hold f′(α₀). The interpolation is performed according to the above formula using fixed point multiplication. A scaling shift is preferably applied before the sum operation.

In this way, many functions which are difficult to calculate at present, such as sine, exponent, square root, logarithm, can be estimated relatively rapidly and using fewer resources. It will be appreciated that a different table is required for each function. If desired, various LUTs can be stored in a single memory. Each table is built using the values of the function at values selected according to the precision desired, preferably according to powers of 2. More precision can be achieved by adding the next values to the table (e.g., the second and further derivatives) and to the calculations required. It will be appreciated that this is necessary only if very high precision is required.

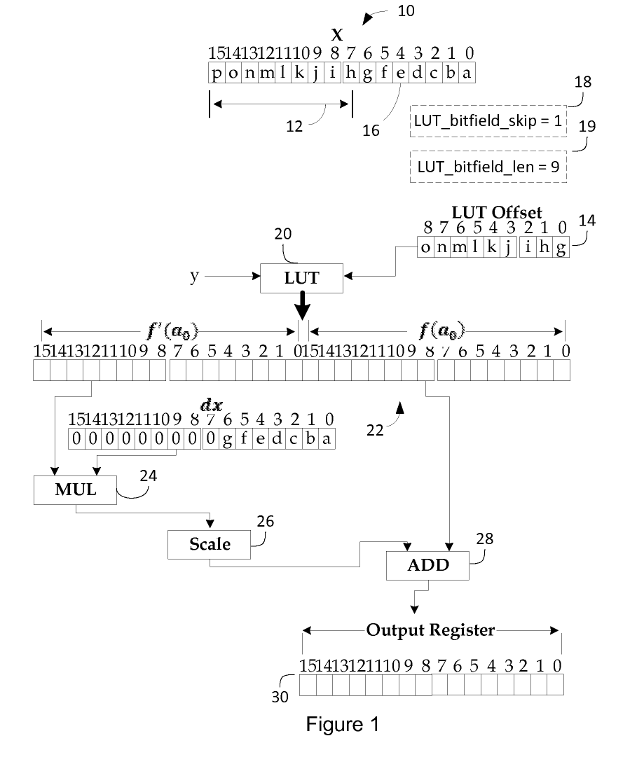

Referring now to FIG. 1, there is shown a schematic illustration of the operation of the processor of the present invention. It uses two instructions:

1. The first step is an instruction which calculates f(a₀) and f′(a₀). The instruction gets two operands:
The input word, an integer operand, which contains x 10, in this example, a 16 bit type integer operand. The MSB 12 (here illustrated as bits 7-15) are used to create a₀, which is an index 14 to the LUT 20 (shown in FIG. 1 as LUT offset). The LSB 16 (here illustrated as bits 0-6) are used to form dx.
The base address for the interpolation table. (Each function has its own table or its own location in a large table).

The base address, LUT address bit field, comes from a special purpose register. In this embodiment, special purpose registers 18 and 19 are used to determine where to start taking bits to a₀ which will be used as offset to the LUT (i.e., how many bits to skip, before starting) and the length of a0 (number of bits). The length of the bit-field determines the size of the interpolation table. It also determines the error, as dx is the LSB field and the error is proportional to dx² . For example, if the bit field length is 8, then dx<2⁻⁸ , which turns the error to about 2⁻¹⁶, which is less than 16 bit fixed point representation accuracy. The result of the look up is stored in a temporary variable 22. In this example, this result has 32 bits. 2. The second step is an interpolation instruction. It has two operands:
x 10, which is the original x variable used in the previous instruction.
Y 22, which is the result of the LUT operation.

This instruction performs the interpolation operation as shown. Y is multiplied 24 by dx. Scaling is provided so as to retain the correct number of bits. The scaling of the multiplication is specified by special purpose register SCALE_REG 26. Its value is constant for each interpolated function. Finally, the result of the scaled multiplication is added 28 to f(a₀). The final result of the requested function as approximated by interpolation is written to an output register 30.

The way dx is extracted defines it to be positive and a₀≦x. So the interpolation is the same for positive and negative values of x. The interpolation table should be organized by 2th complement order (the binary representation of a negative number is its index to the LUT).

The fact that the bit field is not always taken from the MSB helps achieve better accuracy.

It will be appreciated that when using a four lane SIMD, or similar hardware, the same calculation can be performed four times in parallel. Thus, the same function can be calculated substantially simultaneously for four different input words. The processor receives the instruction—what type of operation to perform, the input operands to be operated on, from where to take the operands in the LUT (i.e., start address and offset), and where to write the result.

It will be appreciated that, when the same function must be calculated many times in a row, the operations can be performed in a pipe line, so that one result is output per cycle. In this case, during each cycle, the operands are read from the

Lookup Table for one input word, while the arithmetic engine is calculating the approximation for the previous input word.

While the invention has been described with respect to a limited number of embodiments, it will be appreciated that many variations, modifications and other applications of the invention may be made. It will further be appreciated that the invention is not limited to what has been described hereinabove merely by way of example. Rather, the invention is limited solely by the claims which follow.

1. An algebraic processor comprising:
a programmable hardware unit including:
at least one lookup table storing values of at least one function, said lookup table including two values for each entry;
an arithmetic engine performing a same mathematical operation on two operands from said at least one lookup table and an input operand, thereby estimating a value of said at least one function by means of linear interpolation; and
an output register.

2. The algebraic processor according to claim 1, wherein said arithmetic engine includes a multiplier-accumulator and a scaling module.

3. The algebraic processor according to claim 1, wherein said arithmetic engine performs said same mathematical operation on a plurality of pairs of operands from said at least one lookup table and corresponding input operands, in a single cycle.

4. The algebraic processor according to claim 1, wherein said programmable hardware unit is a vector device.

5. The algebraic processor according to claim 4, wherein said vector device is a multiplier-accumulator having a Single Instruction Multiple Data (SIMD) structure.

6. The algebraic processor according to claim 1, wherein said programmable hardware unit is a scalar device.

7. The algebraic processor according to claim 1, wherein said at least one look up table includes pre-calculated function values and the pre-calculated derivatives of those values and the arithmetic engine performs interpolation from one of these pre-calculated numbers to the required input value, using Taylor polynomials.

8. The algebraic processor according to claim 7, further comprising additional values for each entry, each being a pre-calculated further derivative of said function value.

9. A method for calculating a selected function for an input operand, the method comprising:
calculating, in a programmable hardware unit, an approximate value of a selected function for an input word using linear interpolation from pre-calculated values of said selected function; and
outputting said approximate value of said function of said input word to an output register.

10. A method for calculating a selected function for an input word, the method comprising:
receiving an instruction, according to a selected resolution, for dividing the input word;
dividing said input word, according to said received instruction, into an index for a lookup table and an input operand;
using said index, reading pre-calculated values from said lookup table as operands for at least one function to be calculated; and
performing a same mathematical operation on said operands from said at least one lookup table and an input operand, thereby calculate an approximation of said function of said input word by means of interpolation

11. The method according to claim 10, wherein said mathematical operation is performed on multiple groups of operands in a single cycle.

12. The method according to claim 10, wherein said step of performing is implemented in a multiplier-accumulator SIMD.

13. The method according to claim 10, wherein said mathematical operation is linear interpolation.

14. The method according to claim 10, wherein said mathematical operation includes performing interpolation according to the formula:
f(x)=f(a₀+dx)=f(a₀)+f′(a₀)*dx
using fixed point multiplication.

15. The method according to claim 10,
wherein said operation includes multiplication and summing;
and further comprising applying a scaling shift before said summing operation.
